(19) United States
(12) Patent Application Publication
(10) Pub. No.: US 2010/0130640 A1
(43) Pub. Date: May 27, 2010

(54) SEALANT COMPOSITION FOR REPAIRING A PUNCTURED TIRE

(75) Inventors: Takahiro OKAMATSU, Kanagawa (JP); Kazushi KIMURA, Kanagawa (JP)

Correspondence Address: HAMRE, SCHUMANN, MUELLER & LARSON, P.C., P.O. BOX 2902, MINNEAPOLIS, MN, 55402-0902, US

(73) Assignee: THE YOKOHAMA RUBBER CO., LTD., Tokyo (JP)

(21) Appl. No.: 12/624,077

(22) Filed: Nov. 23, 2009

(30) Foreign Application Priority Data
Nov. 25, 2008 (JP) 2008-299503

(51) Int. Cl. B29C 73/00

(52) U.S. Cl. 523/166

(57) ABSTRACT

The present invention relates to a sealant composition for repairing a punctured tire, which comprises a synthetic resin emulsion, a tackifier and a water glass, and which has a hydrogen ion exponent of 5.5 to 8.5. The sealant composition for repairing a punctured tire has an improved sealing performance and is excellent in storage stability.

### FIELD OF THE INVENTION

The present invention relates to a sealant composition for repairing a punctured tire.

### BACKGROUND OF THE INVENTION

Heretofore, compositions obtained by mixing a natural rubber latex with a tackifier resin emulsion and an antifreeze have been widely used as sealant compositions for repairing punctured tires.

For example, Patent Document 1 describes “a tire puncture sealant containing at least a natural rubber latex, a tackifier resin emulsion, and an antifreeze, wherein relative to 100 parts by weight of a total solid content which is the sum A+B+C of the solid content A of the natural rubber latex, the solid content B of the tackifier resin emulsion, and the antifreeze C, the amount of the solid content A of the natural rubber latex is 30 to 60 parts by weight, the amount of the solid content B of the tackifier resin emulsion is 10 to 30 parts by weight, and the amount of the antifreeze C is 20 to 50 parts by weight, and also an aromatic modified terpene resin is used as the tackifier resin of the tackifier resin emulsion”.

Moreover, Patent Document 2 describes “a puncture sealant containing at least a rubber latex solution and a short fiber, which further contains a clay thickener and wherein the viscosity of the rubber latex solution to which the clay thickener has been added is 3 to 6000 mPa·s in the range of +50° C. to −20° C.”.

However, the natural rubber latex-based puncture sealants described in Patent Documents 1 and 2 have a low storage stability (storage performance). For example, the service life is about 1 year when left in the trunk of a vehicle and there is a problem that when the service life is over, they may solidify or gelate and their fluidity may remarkably decrease, so that they cannot be injected into a punctured tire.

In order to solve the problem, Patent Document 3 has proposed “a tire puncture sealant containing a synthetic resin emulsion and an antifreeze, and having a hydrogen ion exponent of 5.5 to 8.5.

Patent Document 1: JP-A-2004-035867

Patent Document 2: JP-A-2005-170973

Patent Document 3: JP-A-2007-224246

The term “JP-A” as used herein means “an unexamined published Japanese patent application”.

However, the present inventors have investigated, and found that, when the puncture sealants described in Patent Documents 1 and 2 and the tire puncture sealant described in Patent Document 3 are used, it is possible to seal a punctured hole (hereinafter simply referred to as “hole”) having a diameter of about 4 mm caused by a nail or foreign material, however it is difficult to seal a hole having a diameter of about 6 mm caused by a nail or foreign material.

Thus, one of the objects of the present invention is to provide a sealant composition for repairing a punctured tire which improves sealing performance and is also excellent in storage stability.

### SUMMARY OF THE INVENTION

As a result of extensive studies, the present inventors have found that a sealant composition for repairing a punctured tire containing a synthetic resin emulsion and a tackifier, and further containing a water glass has a high sealing performance and is also excellent in storage stability, and thus completed the present invention.

### DETAILED DESCRIPTION OF THE INVENTION

The present invention includes the following embodiments (1) to (10).

(1) A sealant composition for repairing a punctured tire, which comprises a synthetic resin emulsion, a tackifier and a water glass, and which has a hydrogen ion exponent of 5.5 to 8.5.

(2) The sealant composition for repairing a punctured tire of the above (1), wherein the water glass comprises at least one sodium silicate selected from the group consisting of Na₂SiO₃, Na₄SiO₄, Na₂Si₂O₅, and Na₂Si₄O₉.

(3) The sealant composition for repairing a punctured tire of the above (1) or (2), wherein the synthetic resin emulsion is an ethylene-vinyl acetate emulsion.

(4) The sealant composition for repairing a punctured tire of any one of the above (1) to (3), wherein the tackifier comprises at least one resin selected from the group consisting of rosin resins, terpene resins, and hydrogenated terpene resins.

(5) The sealant composition for repairing a punctured tire of any one of the above (1) to (4), wherein the solid content of the water glass is 3 to 70 parts by mass relative to 100 parts by mass of the solid content of the synthetic resin emulsion.

(6) The sealant composition for repairing a punctured tire of any one of the above (1) to (5), wherein the solid content of the tackifier is 50 to 200 parts by mass relative to 100 parts by mass of the solid content of the synthetic resin emulsion.

(7) The sealant composition for repairing a punctured tire of any one of the above (1) to (6), which further comprises an antifreeze.

(8) The sealant composition for repairing a punctured tire of the above (7), wherein the antifreeze comprises at least one member selected from the group consisting of ethylene glycol, propylene glycol, and diethylene glycol.

(9) The sealant composition for repairing a punctured tire of the above (7) or (8), wherein the solid content of the antifreeze is 100 to 400 parts by mass relative to 100 parts by mass of the solid content of the synthetic resin emulsion.

(10) The sealant composition for repairing a punctured tire of any one of the above (1) to (9), wherein the hydrogen ion exponent is 6.0 to 8.0.

As explained below, the present invention is useful since it can provide a sealant composition for repairing a punctured tire which has an improved sealing performance and is excellent in storage stability.

Moreover, the sealant composition for repairing a punctured tire according to the present invention is quite useful since it exhibits an excellent sealing performance even against a hole (hole having a diameter of about 6 mm caused by a nail or foreign material) in both of center grooves and shoulder grooves.

The following will describe the present invention in more detail.

The sealant composition for repairing a punctured tire according to the present invention is a composition which comprises a synthetic resin emulsion, a tackifier, and a water glass, and which has a hydrogen ion exponent of 5.5 to 8.5.

Next, respective components of the sealant composition for repairing a punctured tire according to the present invention will be described in detail.

### <Synthetic Resin Emulsion>

The synthetic resin emulsion used in the sealant composition for repairing a punctured tire according to the present invention is not particularly limited and conventionally known synthetic resin emulsions may be used.

Specifically, examples of the above synthetic resin emulsion include those containing urethane emulsions, acrylic emulsions, styrene-butadiene emulsions, nitrile emulsions, polyolefin emulsions, ethylene-vinyl acetate emulsions, vinyl acetate emulsions, and polyvinyl chloride emulsions. They may be used individually or may be used in combination of two or more thereof. The synthetic resin emulsion preferably contains water or solvents(s), and may further contain other components. The examples of the solvents include methanol, ethanol, isopropyl alcohol, acetone, methyl ethyl ketone, ethyl acetate, butyl acetate and the like.

In the present invention, use of a resin emulsion obtained by copolymerization (emulsion polymerization) using an emulsifying and dispersing agent when the above synthetic resin emulsion is synthesized (polymerized) can result in an excellent compatibility with the water glass to be explained below and improve the sealing performance of the sealant composition for repairing a punctured tire according to the present invention to be obtained.

Examples of the emulsifying and dispersing agent include nonionic surfactants, anionic surfactants, cationic surfactants, and amphoteric surfactants. Of these, nonionic surfactants are preferred since they are neutral and have little odor. Particularly, it is preferable to use a water-soluble polymer and it is more preferable to use polyvinyl alcohol (PVA).

Moreover, in the present invention, an ethylene-vinyl acetate emulsion is preferred because the storage stability of the sealant composition for repairing a punctured tire according to the present invention to be obtained is further improved.

The following will describe the ethylene-vinyl acetate emulsion in detail.

### Ethylene-Vinyl Acetate Emulsion

The above ethylene-vinyl acetate emulsion (hereinafter referred to as “EVA emulsion”) is not particularly limited and conventionally known EVA emulsions may be used.

As the above EVA emulsions, an aqueous emulsion obtained by copolymerization (emulsion polymerization) of ethylene with a vinyl acetate monomer using the above emulsifying and dispersing agent and the like are suitably exemplified.

The mass ratio of ethylene to the vinyl acetate monomer to be mixed at the copolymerization is preferably 10/90 to 40/60.

In the present invention, if desired, other monomers may be copolymerized in the above copolymerization. Specifically, examples of the other monomers include acrylate ester such as 2-ethylhexyl acrylate, butyl acrylate, and ethyl acrylate; methacrylate ester such as methyl methacrylate and butyl methacrylate; and vinyl chloride and vinyl ester such as vinyl versatate. Moreover, as the other monomers, in addition to a monomer having a carboxyl group such as acrylic acid and methacrylic acid, various monomers having a functional group such as a sulfonic acid group, a hydroxyl group, an epoxy group, a methylol group, an amino group, or an amido group can be also used.

The weight-average molecular weight of the above EVA emulsion is preferably 10,000 to 500,000, more preferably 50,000 to 200,000.

Moreover, the above EVA emulsion has the solid content of preferably 40 to 70% by mass, more preferably 50 to 65% by mass.

Herein, the solid content of the synthetic resin emulsion according to the present invention means a total of respective components contained in the synthetic resin emulsion excluding water and solvent(s).

As the above EVA emulsion, a commercially available product may be used and specific examples thereof include an ethylene-vinyl acetate emulsion manufactured by Sumika Chemtex Co., Ltd. (SUMIKAFLEX S7400, S400HQ, S467, 510HQ, 1010, 410HQ, 408HQE, 950HQ, 951HQ).

### <Tackifier>

The tackifier used in the sealant composition for repairing a punctured tire according to the present invention is not particularly limited and conventionally known tackifiers may be used.

Specifically, examples of the above tackifier include those containing rosin resins such as rosin ester, polymerized rosin ester, and modified rosins; terpene resins such as terpene phenol and aromatic terpenes; hydrogenated terpene resins obtained by terpene resins; phenol resins; and xylene resins. They may be used individually or may be used in combination of two or more thereof. The tackifier preferably contains water or solvent(s), and may further contain other components. The examples of the solvents include methanol, ethanol, isopropyl alcohol, acetone, methyl ethyl ketone, ethyl acetate, butyl acetate and the like.

Particularly, emulsions obtained by emulsifying these resins using the above emulsifying and dispersing agent are preferred for the reason of excellent compatibility with the above synthetic resin emulsions.

Moreover, a tackifier containing at least one resin selected from the group consisting of rosin resins, terpene resins, and hydrogenated terpene resins is preferred for the reason that the sealing performance of the sealant composition for repairing a punctured tire according to the present invention to be obtained is further improved.

In the present invention, the amount of the solid content of the above tackifier is preferably 50 to 200 parts by mass, more preferably 60 to 150 parts by mass, further preferably 70 to 130 parts by mass relative to 100 parts by mass of the total solid content of the above synthetic resin emulsion.

When the amount of the solid content of the above tackifier falls within the above range, the sealing performance of the sealant composition for repairing a punctured tire according to the present invention to be obtained is further improved.

Herein, the solid content of the tackifier means a total of respective components contained in the tackifier excluding water and solvent(s).

### <Water Glass>

The water glass used in the sealant composition for repairing a punctured tire according to the present invention is not particularly limited and conventionally known water glasses may be used.

The use of the water glass can improve the sealing performance while the excellent storage stability of the tire sealant composition for repairing a punctured tire according to the present invention to be obtained is maintained.

It is considered that this is achieved by the solidification function of the water glass. Specifically, the sealant composition for repairing a punctured tire is injected into a tire though an air-filling part of the tire, arrives at a punctured hole by running the vehicle after air is filled to a predetermined air pressure, and seals the hole through the formation of an aggregate of rubber particles by compression force and shear force imparted when the tire is rotated and touches ground. It is considered that the incorporation of the water glass accelerates the formation of the aggregate.

In the present invention, the above water glass preferably contains at least one sodium silicate selected from the group consisting of Na₂SiO₃, Na₄SiO₄, Na₂Si₂O₅, and Na₂Si₄O₉, for the reasons of easy formation of the aggregate and easy availability. The water glass preferably contains water or solvent(s), and may further contain other components. The examples of the solvents include methanol, ethanol, isopropyl alcohol, acetone, methyl ethyl ketone, ethyl acetate, butyl acetate and the like.

Moreover, in the present invention, the amount of the solid content of the above water glass is preferably 3 to 70 parts by mass relative to 100 parts by mass of the total solid content of the above synthetic resin emulsion. When the amount of the solid content of the above water glass falls within the range, the sealing performance of the sealant composition for repairing a punctured tire according to the present invention to be obtained is further improved.

Furthermore, the amount of the solid content of the above water glass is more preferably 4 to 45 parts by mass relative to 100 parts by mass of the total solid content of the above synthetic resin emulsion. When the amount of the solid content of the above water glass falls within the range, the sealing performance of the sealant composition for repairing a punctured tire according to the present invention to be obtained is further improved and also the storage stability becomes excellent.

Herein, the solid content of the water glass means a total of respective components contained in the water glass excluding water and solvent(s).

As the above water glass, a commercially available product may be used and specific examples thereof include a water glass manufactured by Wako Pure Chemical Industries, Ltd.

### <Antifreeze>

The sealant composition for repairing a punctured tire according to the present invention preferably further contains an antifreeze for the reason that the sealant composition can be used even under an atmosphere below the freezing point. Specifically, examples of the above antifreeze include ethylene glycol, propylene glycol, and diethylene glycol. They may be used individually or may be used in combination of two or more thereof.

In the present invention, when the above antifreeze is contained, the amount of the solid content of the antifreeze is 100 to 400 parts by mass, more preferably 100 to 300 parts by mass, and further preferably 110 to 200 parts by mass relative to 100 parts by mass of the solid content of the synthetic resin emulsion.

When the amount of the solid content of the antifreeze falls within the above ranges, performance to prevent the sealant composition for repairing a punctured tire according to the present invention to be obtained from freezing is sufficiently exhibited.

Herein, the solid content of the antifreeze means a total of respective components contained in the antifreeze excluding water and solvent(s).

From the viewpoint of accelerating the formation of aggregate of the aforementioned rubber particles, the sealant composition for repairing a punctured tire according to the present invention preferably further contains a component for crosslinking the above synthetic resin emulsion.

Specifically, examples of the above component include adipic acid dihydrazide, oxazoline group-containing emulsions, oxazoline group-containing water-soluble resins, and carbodiimide-containing resins.

In addition to the aforementioned respective components, the sealant composition for repairing a punctured tire according to the present invention may contain, as desired, any of various additives such as a filler, an antiaging agent, an antioxidant, a pigment (dye), a plasticizer, a thixotropic agent, a UV absorber, a flame retardant, a surfactant (including a leveling agent), a dispersant, a dehydrating agent, and an antistatic agent.

Organic or inorganic fillers in various forms may be mentioned as the filler. Specifically, examples thereof include fumed silica, pyrogenic silica, precipitated silica, crushed silica, fused silica; diatomaceous earth; iron oxide, zinc oxide, titanium oxide, barium oxide, magnesium oxide; calcium carbonate, magnesium carbonate, zinc carbonate; agalmatolite clay, kaolin clay, calcined clay; carbon black; and fatty acid-treated products, resin acid-treated products, urethane compound-treated products, and fatty acid ester-treated products thereof.

Specifically, examples of the antiaging agent include compounds such as hindered phenol.

Specifically, examples of the antioxidant include butylhydroxytoluene (BHT) and butylhydroxyanisole (BHA) and the like.

Specifically, examples of the pigment include inorganic pigments such as titanium oxide, zinc oxide, ultramarine blue, red iron oxide, lithopone, lead, cadmium, iron, cobalt, aluminum, hydrochloride, and sulfate; and organic pigments such as azo pigment, phthalocyanine pigment, quinacridone pigment, quinacridone quinone pigment, dioxazine pigment, anthrapyrimidine pigment, anthanthrone pigment, indanthrone pigment, flavanthrone pigment, perylene pigment, perinone pigment, diketopyrrolopyrrole pigment, quinonaphthalone pigment, anthraquinone pigment, thioindigo pigment, benzimidazolone pigment, isoindoline pigment, and carbon black.

Specifically, examples of the plasticizer include diisononyl phthalate (DINP); dioctyl adipate, isodecyl succinate; diethylene glycol dibenzoate, pentaerythritol ester; butyl oleate, methyl acetyl ricinoleate; tricresyl phosphate, trioctyl phosphate; adipic acid propylene glycol polyester, and adipic acid butylene glycol polyester.

Specifically, examples of the thixotropic agent include AEROSIL (manufactured by Nippon Aerosil Co., Ltd.) and DISPARLON (manufactured by Kusumoto Chemicals, Ltd.).

Specifically, examples of the flame retardant include chloroalkyl phosphate, dimethyl methylphosphonate, a bromine/phosphorus compound, ammonium polyphosphate, neopentyl bromide-polyether, and brominated polyether.

Specifically, examples of the surfactant include anionic surfactants such as alkali metal salt of rosin, alkylbenzene sulfonate, polyoxyethylene alkylphenyl ether sulfate ester salt, alkylnaphthalene sulfonate salt, polyoxy mono- and di-styrylphenyl ether sulfosuccinate monoester salt, and alkylphenoxy polyoxyethylene propylsulfonate salt; nonionic surfactants such as polyoxyethylene alkyl ether and polyoxyethylene alkylphenyl ether; and cationic surfactants such as tetraalkyl ammonium chloride, trialkylbenzyl ammonium chloride, alkylamine, monooxyethylene alkylamine, and polyoxyethylene alkylamine.

Specifically, examples of the antistatic agent include quaternary ammonium salt; and hydrophilic compounds such as polyglycol and an ethylene oxide derivative.

The process for producing the sealant composition for repairing a punctured tire according to the present invention is not particularly limited. For example, there may be mentioned a process in which the above synthetic resin emulsion, tackifier, and water glass and, if desired, the antifreeze and any of the various additives are charged into a reaction vessel and then the whole is sufficiently kneaded using a stirrer such as a blend mixer under reduced pressure.

The sealant composition for repairing a punctured tire according to the present invention has a hydrogen ion exponent (pH) of 5.5 to 8.5. When the pH falls within this range, steel code is hardly corroded. Moreover, the sealant composition for repairing a punctured tire according to the present invention can reduce the amount of ammonia or the like to be added or does not necessitate its addition by using the synthetic resin emulsion which is relatively stable when the pH falls within the above range, so that pungent odor is little.

From the viewpoint of being more excellent in these characteristics, the pH of the sealant composition for repairing a punctured tire according to the present invention is more preferably 6.0 to 8.0, and further preferably 6.5 to 8.0.

The method for measuring the pH of the sealant composition for repairing a punctured tire according to the present invention is not particularly limited, and conventionally known methods may be used. Additionally, the pH of the present invention is that measured at the normal temperature (25° C.).

The pH may be adjusted to the above range by adding an acid or a base to the sealant composition for repairing a punctured tire according to the present invention.

The above acid is not particularly limited and specifically, examples thereof include inorganic acid such as hydrochloric acid, sulfuric acid, nitric acid, phosphoric acid, and phosphorous acid; and organic acid such as acetic acid, propionic acid, formic acid, butyric acid, lactic acid, malic acid, and citric acid. They may be used individually or may be used in combination of two or more thereof.

The above base is not particularly limited but those having no pungent odor are preferred. Specifically, examples thereof suitably include sodium hydroxide, potassium hydroxide, and tertiary amine. They may be used individually or may be used in combination of two or more thereof. Of these, triethylamine is preferred from the viewpoints of safety and water resistance after sealing.

The following will describe a method for using the sealant composition for repairing a punctured tire according to the present invention. However, the method for using the sealant composition for repairing a punctured tire according to the present invention is not limited to the following method.

First, the sealant composition for repairing a punctured tire according to the present invention is injected into a tire though an air-filling part of a tire. A method for injecting the sealant composition for repairing a punctured tire according to the present invention into the tire is not particularly limited and conventionally known methods can be used. For example, a method of using a syringe, a spray can, or the like may be mentioned. The amount of the sealant composition for repairing a punctured tire according to the present invention to be injected into the tire is not particularly limited and is suitably selected depending on the size of the punctured hole or the like.

Next, air is filled to a predetermined air pressure.

Thereafter, the vehicle is run. An aggregate of the synthetic resin particles and the like is formed by compression force or shear force imparted when the tire is rotated and touches ground, and thus a punctured hole can be sealed.

Unless otherwise indicated, the percentages, ratios, parts and the like used in this specification are by mass, which is the same as by weight.

The following will specifically describe the present invention with reference to Examples. However, the present invention is not limited thereto.

### Examples 1 to 10, Comparative Example 1

The respective components listed in Table 1 below were mixed in compositions shown in Table 1 using a stirrer to obtain respective sealant compositions for repairing a punctured tire shown in Table 1. In this connection, a numeral listed in Table 1 is a part by mass in terms of the solid content.

The hydrogen ion exponent of each sealant composition for repairing a punctured tire obtained was measured with a pH meter (manufactured by Hitachi High-Technologies Corporation). The pH of each sealant composition for repairing a punctured tire at the normal temperature (25° C.) was within the rage of 6 to 8.5.

Moreover, each sealant composition for repairing a punctured tire was evaluated for the sealing performance and storage stability by the methods shown below. The results are shown in Table 1.

### <Sealing Performance>

First, a punctured hole (diameter of 6 mm) was made at a center groove of tread of a tire.

Then, the tire having the punctured hole was mounted on a drum tester, the sealant composition for repairing a punctured tire obtained in the above was injected from the valve nozzle of the tire, and then air was filled so that the tire inner pressure reached 250 kPa.

Thereafter, the above tire was run under conditions of a load of 350 kg and a rate of 30 km per hour and a running time (minute) until an air leak stopped was measured. In this connection, the presence of the air leak was confirmed visually or by spraying soap water on around the punctured hole.

When the running time is 20 minutes or shorter, it is considered that the sealant composition for repairing a punctured tire is excellent in sealing performance.

### (Storage Stability)

The resulting sealant composition for repairing a punctured tire was placed in a vessel, which was then purged with nitrogen, hermetically sealed, and left standing at 90° C. for 50 days. Thereafter, the state of the sealant composition for repairing a punctured tire was observed and the dispersion state was visually checked. A sealant composition having no sedimentation or separation was evaluated as “O” which means that it was excellent in storage stability.

TABLE 1

| | | | | | | | | | | | Comparative |
|---|---|---|---|---|---|---|---|---|---|---|---|
| | Example | | | | | | | | | | Example |
| | 1 | 2 | 3 | 4 | 5 | 6 | 7 | 8 | 9 | 10 | 1 |
| Synthetic resin | 100 | | 100 | 100 | 100 | 100 | 100 | 100 | 100 | 100 | 100 |
| emulsion 1 | | | | | | | | | | | |
| Synthetic resin | | 100 | | | | | | | | | |
| emulsion 2 | | | | | | | | | | | |
| Tackifier 1 | 33.3 | 33.3 | | | 33.3 | 33.3 | 33.3 | 33.3 | 33.3 | 33.3 | 33.3 |
| Tackifier 2 | | | 33.3 | | | | | | | | |
| Tackifier 3 | | | | 33.3 | | | | | | | |
| Antifreeze 1 | 120 | 120 | 120 | 120 | | | 120 | 120 | 120 | 120 | 120 |
| Antifreeze 2 | | | | | 120 | | | | | | |
| Antifreeze 3 | | | | | | 120 | | | | | |
| Water glass | 5 | 5 | 5 | 5 | 5 | 5 | 30 | 45 | 3 | 1 | 0 |
| Sealing | 8 | 8 | 8 | 8 | 7 | 8 | 5 | 5 | 8 | 8 | >30 |
| performance | | | | | | | | | | | |
| (minute) | | | | | | | | | | | |
| Storage stability | ◯ | ◯ | ◯ | ◯ | ◯ | ◯ | ◯ | ◯ | ◯ | ◯ | ◯ |

The respective components listed in Table 1 above are as follows:
Synthetic resin emulsion 1: EVA emulsion (SUMIKAFLEX S510HQ, manufactured by Sumika Chemtex Co., Ltd., solid content: 55% by mass)
Synthetic resin emulsion 2: EVA emulsion (SUMIKAFLEX 408HQE, manufactured by Sumika Chemtex Co., Ltd., solid content: 52% by mass)
Tackifier 1: rosin resin emulsion (HARIESTER SK508, manufactured by Harima Chemicals, Inc., solid content: 55% by mass)
Tackifier 2: rosin ester resin emulsion (E720, manufactured by Arakawa Chemical Industries, Ltd., solid content: 50% by mass)
Tackifier 3: terpene resin emulsion (R1050, manufactured by Yasuhara Chemical Co., Ltd., solid content: 55% by mass)
Antifreeze 1: propylene glycol (manufactured by Sankyo Chemical Co., Ltd., solid content: 100% by mass)
Antifreeze 2: ethylene glycol (manufactured by Wako Pure Chemical Industries, Ltd., solid content: 100% by mass)
Antifreeze 3: diethylene glycol (manufactured by Wako Pure Chemical Industries, Ltd., solid content: 100% by mass)
Water glass: manufactured by Wako Pure Chemical Industries, Ltd., solid content: 65% by mass

As apparent from the results shown in Table 1 above, it was found that the sealant composition for repairing a punctured tire prepared without mixing a water glass (Comparative Example 1) required 30 minutes or more for sealing the punctured hole (diameter of 6 mm) and thus was poor in sealing performance.

To the contrary, it was found that the sealant compositions for repairing a punctured tire prepared by mixing a water glass (Examples 1 to 10) are excellent in storage stability and also can seal even the punctured hole having a diameter of 6 mm for a short period of time and thus are excellent in sealing performance.

While the invention has been described in detail and with reference to specific embodiments thereof, it will be apparent to one skilled in the art that various changes and modifications can be made therein without departing from the scope thereof.

This application is based on Japanese patent application No. 2008-299503 filed Nov. 25, 2008, the entire contents thereof being hereby incorporated by reference.

What is claimed is:

1. A sealant composition for repairing a punctured tire, which comprises a synthetic resin emulsion, a tackifier and a water glass, and which has a hydrogen ion exponent of 5.5 to 8.5.

2. The sealant composition for repairing a punctured tire according to claim 1, wherein the water glass comprises at least one sodium silicate selected from the group consisting of Na₂SiO₃, Na₄SiO₄, Na₂Si₂O₅, and Na₂Si₄O₉.

3. The sealant composition for repairing a punctured tire according to claim 1, wherein the synthetic resin emulsion is an ethylene-vinyl acetate emulsion.

4. The sealant composition for repairing a punctured tire according to claim 1, wherein the tackifier comprises at least one resin selected from the group consisting of rosin resins, terpene resins, and hydrogenated terpene resins.

5. The sealant composition for repairing a punctured tire according to claim 1, wherein the solid content of the water glass is 3 to 70 parts by mass relative to 100 parts by mass of the solid content of the synthetic resin emulsion.

6. The sealant composition for repairing a punctured tire according to claim 1, wherein the solid content of the tackifier is 50 to 200 parts by mass relative to 100 parts by mass of the solid content of the synthetic resin emulsion.

7. The sealant composition for repairing a punctured tire according to claim 1, which further comprises an antifreeze.

8. The sealant composition for repairing a punctured tire according to claim 7, wherein the antifreeze comprises at least one member selected from the group consisting of ethylene glycol, propylene glycol, and diethylene glycol.

9. The sealant composition for repairing a punctured tire according to claim 7, wherein the solid content of the antifreeze is 100 to 400 parts by mass relative to 100 parts by mass of the solid content of the synthetic resin emulsion.

10. The sealant composition for repairing a punctured tire according to claim 1, wherein the hydrogen ion exponent is 6.0 to 8.0.
